(19) United States
(12) Patent Application Publication
(10) Pub. No.: US 2009/0040961 A1
(43) Pub. Date: Feb. 12, 2009

(54) AGGREGATION CONTROL METHOD, AGGREGATE NODE, DEAGGREGATE NODE

(75) Inventors: Toyoki Ue, Kanagawa (JP); Takako Hori, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/095,079

(22) PCT Filed: Nov. 28, 2006
(86) PCT No.: PCT/JP2006/323742

§ 371 Date: May 27, 2008

(30) Foreign Application Priority Data
Nov. 28, 2005 (JP) 2005-342375

(51) Int. Cl. H04B 7/14

(52) U.S. Cl. 370/315

(57) ABSTRACT

A technology is disclosed that provides an aggregation control method, an aggregate node, and a deaggregate node that can quickly and efficiently manage aggregation. Through the technology, a deaggregate node 113 transitions itself to a mode performing a release process for a QoS path within an area between the aggregate node and the deaggregate node, based on a processing message from the aggregate node before movement. The aggregate node transmits an establishment request message for establishing a new QoS path after movement to communication partner nodes 141 to 145. When a relay node itself is a crossover node based on the establishment request message, the relay node transmits a release request message requesting release of the QoS path within the area to the deaggregate node. The deaggregate node releases the QoS path within the area when at least one release request message is received.

### TECHNICAL FIELD

The present invention relates to an aggregation control method, an aggregate node, and a deaggregate node. The aggregation control method, the aggregate node, and the deaggregate node are used to control aggregation in a communication network including aggregated sessions.

### BACKGROUND ART

Tunneling technology is widely used in a mobile communication network. For example, the tunnel technology is used from a mobile node (MN) to a home agent (HA) in mobile internet protocol (MIP), from a MN to a mobility anchor point (MAP) in hierarchical mobile IP (HMIP), and from a MN to a gateway general packet radio service (GPRS) support node (GGSN) in 3^{rd} Generation Partnership Project (3GPP). Within these tunnels, data traffics of different sessions are aggregated. When an additional service (refer to Non-Patent Documents 1 and 2, below), such as a Quality of Service (QoS) guarantee, is provided to these data traffics using path-coupled signaling, such as Resource reRerVation Protocol (RSVP) and Next Step In Signaling (NSIS), aggregation is performed within the tunnel for the signaling. In other words, an end-to-end signaling message is sent outside of the tunnel. A signaling message for aggregation is sent within the tunnel. Mapping of these signalings is performed at an entrance and an exit of the tunnel.

At the same time, in NSIS, a QoS path is required to be established before the MN moves or a preparation for establishing the QoS path is required to be made so that the QoS can be received without interruption. To prevent double resource reservation from occurring at this time between a current QoS path and a new QoS path, a section at which the two paths overlap is required to be identified and suitable processing is required to be performed. To solve this issue, various proposals are currently being made within the NSIS working group (WG). For example, as in a technology disclosed in Non-Patent Document 3 below, a following method and the like are proposed. Before a node moves, a message including a session identifier that is currently being used is transmitted to a proxy on a subnet that is a movement destination. The proxy then transmits the message including the session identifier over a path on which the QoS path is to be newly established. As a result, a QoS NSIS entity (QNE) at which the current path and the new path start to overlap, namely a crossover node (CRN), is identified. Establishment of a new path, updating of a path, and release of a previous path are performed using the CRN.

Here, as shown in FIG. 8, a plurality of signaling nodes (SN [also referred to as a signal node]; SN 101′ to SN105′) respectively communicate with communication partner nodes (end node 141′ to end node 145′), via a domain 120′. Sessions are aggregated within the domain 120′. An additional service (QoS guarantee service, herein) is provided to each session through use of a method such as NSIS. When an aggregator 111′ moves and reaches a position of an aggregator 115′ in this state, a procedure for releasing tunnel QoS paths established between the aggregator 111′ and a deaggregator 113′ (when, for example, the existing NSIS procedure is used) is as follows.

First, the MN sends a message for establishing a new QoS path to respective communication partner nodes at the movement destination, via the aggregator 115′ and a deaggregator 117′. Each CRN (CRN 131′ to 135′) is discovered. To release the previous QoS path, each CRN transmits a message for release (referred to as a tear message) towards a direction in which the aggregator 111′ had been present. Every time the tear message reaches the deaggregator 113′, the deaggregator 113′ compares information in the message (end-to-end QoS path) and information on the tunnel QoS path. To release the QoS within the tunnel that has been reserved for this path, the deaggregator 113′ sends a message for updating into the tunnel. When the tear messages from all CRN reach the deaggregator 113′ and the reserved QoS within the tunnel is zero, the deaggregator 113′ transmits the tear message for releasing the tunnel QoS paths in the direction in which the aggregator 111′ had been present.

Patent Document 1: US2004/0260796 A1 “Method and arrangement in an ip network”
Patent Document 2: U.S. Pat. No. 6,069,889 A “Aggregation of data flows on switched network paths”
Non-Patent Document 1: R. Braden, et al. “Resource ReSerVation Protocol (RSVP)”, RFC2205, September 1997
Non-Patent Document 2: IETF Next Step In Signaling (NSIS) (http://www.ietf.org/html.charters/nsis-charter.html)
Non-Patent Document 3: T. Ue, T. Sanda, K. Honma, “QoS Mobility Support with Proxy-assisted Fast Crossover Node Discovery”, WPMC2004, September 2004

However, the deaggregator 113′ cannot send the tear message for releasing the tunnel QoS paths until after receiving the tear messages (for respective end-to-end QoS paths) from all CRN. Therefore, time is required until the tunnel QoS paths are released. The deaggregator 113′ sends an update message into the tunnel each time the tear messages (for respective end-to-end QoS paths) are received from all CRN. Therefore, the number of signaling messages flowing through the tunneling section until the tunnel QoS paths are released increases. A load is placed on the deaggregator 113′ to map the tear message with information on the inside of the tunnel, each time the tear messages (for respective end-to-end QoS paths) are received from all CRN.

If an error occurs in even one tear message sent from the CRN before the tear message reaches the deaggregator 113′, the tunnel QoS paths are not released (state is maintained until timeout). These issues are considered to similarly arise when the aggregator is the MN in FIG. 8 and the MN communicates with a plurality of partners using a plurality of sessions. Several inventions (refer to Patent Documents 1 and 2, above) attempt to resolve aggregation problems occurring within a communication network. However, these inventions are related to QoS management and are unrelated to signaling. Mobility support is not taken into consideration.

### DISCLOSURE OF THE INVENTION

The present invention has been achieved in light of the above-described problems. An object of the present invention is to provide an aggregation control method, an aggregate node, and a deaggregate node, in which the aggregation control method, the aggregate node, and the deaggregate node can quickly and efficiently control aggregation.

In order to achieve the object, in the present invention, an aggregation control method is provided in a communication network in which a mobile node and a communication partner node that is a communication partner of the mobile node communicate over an area in which signaling sessions between the mobile node and the communication partner node are aggregated by an aggregate node. The aggregate node and a deaggregate node are positioned on an edge of the aggregated area. A relay node that relays a signaling message between the deaggregate node and the communication partner node is provided. When the aggregate node moves from the edge of the aggregated area to an edge of another area, the aggregation control method includes a step at which the deaggregate node transitions the deaggregate node itself to a mode performing a release process for a QoS path within the area configured between the aggregate node and the deaggregate node itself, based on a processing message including process request information of after the movement starts received in advance from the aggregate node before movement. The aggregation control method also includes a step at which the aggregate node transmits an establishment request message for establishing a new QoS path after movement to the communication partner node. The aggregation control method also includes a step at which the relay node transmits a release request message requesting release of the QoS path within the area to the deaggregate node when the relay node judges that the relay node itself is a crossover node at which new and old communication paths converge and separate on the communication network because of the movement, based on the transmitted establishment request message. The aggregation control method also includes a step at which the deaggregate node releases the QoS path within the area when at least one release request message is received. As a result of the configuration, the aggregation can be quickly and efficiently managed. The aggregate node and the deaggregate node are also respectively referred to as an aggregator and a deaggregator, hereinafter.

In the aggregation control method of the invention, a preferred aspect of the invention is that the process request information of the processing message is information used to request the release of the QoS path within the area through reception of at least one release request message when the movement of the aggregate node is detected. As a result of the configuration, the QoS path before to the handover can be quickly released through reception of one release request message.

In the present invention, an aggregation control method is provided in a communication network in which a mobile node and a communication partner node that is a communication partner of the mobile node communicate over an area in which signaling sessions between the mobile node and the communication partner node are aggregated by an aggregate node. The aggregate node and a deaggregate node are positioned on an edge of the aggregated area. A relay node that relays a signaling message between the deaggregate node and the communication partner node is provided. When the mobile node under the aggregate node moves from the aggregate node, the aggregation control method includes a step at which the aggregate node transmits to the deaggregate node a movement message of the movement of the mobile node including a processing message including process request information of after the movement starts, received in advance from the mobile node before the movement of the mobile node. The aggregation control method also includes a step at which the deaggregate node transitions the deaggregate node itself to a mode performing a release process for a QoS path within the area configured between the aggregate node and the deaggregate node itself, based on the received movement message. The aggregation control method also includes a step at which the mobile node transmits an establishment request message for establishing a new QoS path after movement to the communication partner node. The aggregation control method also includes a step at which the relay node transmits a release request message requesting release of the QoS path within the area to the deaggregate node, when the relay node judges that the relay node itself is a crossover node at which new and old communication paths converge and separate on the communication network because of the movement, based on the transmitted establishment request message. The aggregation control method also includes a step at which the deaggregate node releases the QoS path within the area when at least one release request message is received. As a result of the configuration, the aggregation can be quickly and efficiently managed.

In the aggregation control method of the invention, a preferred aspect of the invention is that the process request information of the processing message is information used to request the release of the QoS path within the area through reception of at least one release request message, when the movement of the mobile node is detected. As a result of the configuration, the QoS path before to the handover can be quickly released through reception of one release request message.

In the present invention, an aggregation control method is provided in a communication network in which a mobile node and a communication partner node that is a communication partner of the mobile node communicate over an area in which signaling sessions between the mobile node and the communication partner node are aggregated by an aggregate node. The aggregate node and a deaggregate node are positioned on an edge of the aggregated area. A relay node that relays a signaling message between the deaggregate node and the communication partner node is provided. When the mobile node under the aggregate node moves from the aggregate node, the aggregation control method includes a step at which the aggregate node releases the QoS path configured within the area configured between the aggregate node itself and the deaggregate node, based on a processing message including process request information of after the movement starts, received in advance from the mobile node before the movement of the mobile node. As a result of the configuration, the aggregation can be quickly and efficiently managed.

In the aggregation control method of the invention, a preferred aspect of the invention is that, the process request information of the processing message is information used to request the release of the QoS path within the area without reception of a release request message for the QoS path within the area, when the movement of the mobile node is detected. As a result of the configuration, the QoS path before to the handover can be quickly released without reception of one release request message.

In the present invention, an aggregate node is provided in a communication network in which a mobile node and a communication partner node that is a communication partner of the mobile node communicate over an area in which signaling sessions between the mobile node and the communication partner node are aggregated by the aggregate node. The aggregate node and a deaggregate node are positioned on an edge of the aggregated area. A relay node that relays a signaling message between the deaggregate node and the communication partner node is provided. When the aggregate node itself moves from the edge of the aggregated area to an edge of another area, the aggregate node includes a message generating means that generates a processing message including process request information of after the aggregate node itself starts moving, before moving. The aggregate node also includes a transmitting means that transmits the generated processing message to the deaggregate node and an establishment request message for establishing a new QoS path after movement to the communication partner node. As a result of the configuration, the aggregation can be quickly and efficiently managed.

In the aggregate node of the invention, a preferred aspect of the invention is that the process request information of the processing message is information used to request the release of the QoS path within the area through reception of at least one release request message requesting release of the QoS path within the area configured between the aggregate node and the deaggregate node, when the movement of the aggregate node is detected. As a result of the configuration, the QoS path before to the handover can be quickly released through reception of one release request message.

In the present invention, an aggregate node is provided in a communication network in which a mobile node and a communication partner node that is a communication partner of the mobile node communicate over an area in which signaling sessions between the mobile node and the communication partner node are aggregated by the aggregate node. The aggregate node and a deaggregate node are positioned on an edge of the aggregated area. A relay node that relays a signaling message between the deaggregate node and the communication partner node is provided. When the mobile node under the aggregate node itself moves from the aggregate node, the aggregate node includes a receiving means that receives a processing message including process request information of after the movement of the mobile node starts, from the mobile node before movement. The aggregator also includes a movement detecting means that detects the movement of the mobile node. The aggregator also includes a message generating means that generates a movement message of the movement of the mobile node including the processing message, when the movement detecting means detects the movement of the mobile node. The aggregator also includes a transmitting means that transmits the generated movement message to the deaggregate node. As a result of the configuration, the aggregation can be quickly and efficiently managed.

In the aggregate node of the invention, a preferred aspect of the invention is that the process request information of the processing message is information used to request the release of the QoS path within the area through reception of at least one release request message requesting release of the QoS path within the area configured between the aggregate node and the deaggregate node, when the movement of the mobile node is detected. As a result of the configuration, the QoS path before to the handover can be quickly released through reception of one release request message.

In the present invention, an aggregate node is provided in a communication network in which a mobile node and a communication partner node that is a communication partner of the mobile node communicate over an area in which signaling sessions between the mobile node and the communication partner node are aggregated by the aggregate node. The aggregate node and a deaggregate node are positioned on an edge of the aggregated area. A relay node that relays a signaling message between the deaggregate node and the communication partner node is provided. When the mobile node under the aggregate node itself moves from the aggregate node, the aggregate node includes a receiving means that receives a processing message including process request information of after the movement of the mobile node starts, from the mobile node before movement. The aggregate node also includes a movement detecting means that detects the movement of the mobile node. The aggregate node also includes a release processing means that releases the QoS path within the area configured between the aggregate node and the deaggregate node based on the received processing message, when the movement detecting means detects the movement of the mobile node. As a result of the configuration, the aggregation can be quickly and efficiently managed.

In the aggregate node of the invention, a preferred aspect of the invention is that the process request information of the processing message is information used to request the release of the QoS path within the area without reception of a release request message for the QoS path within the area, when the movement of the mobile node is detected. As a result of the configuration, the QoS path before to the handover can be quickly released without reception of one release request message.

In the present invention, a deaggregate node is provided in a communication network in which a mobile node and a communication partner node that is a communication partner of the mobile node communicate over an area in which signaling sessions between the mobile node and the communication partner node are aggregated by an aggregate node. The aggregate node and the deaggregate node are positioned on an edge of the aggregated area. A relay node that relays a signaling message between the deaggregate node and the communication partner node is provided. When the aggregate node moves from the edge of the aggregated area to an edge of another area, the deaggregate node includes a receiving means that receives a processing message including process request information of after the movement starts from the aggregate node before movement. The deaggregate node also includes a movement detecting means that detects the movement of the aggregate node. The deaggregate node also includes a transitioning means that transitions the deaggregate node itself to a mode performing a release process for a QoS path within the area configured between the aggregate node and the deaggregate node itself, based on the received processing message, when the movement detecting means detects the movement of the aggregate node. The deaggregate node also includes a release processing means that releases the QoS path within the area when at least one release request message requesting release of the QoS path within the area is received. As a result of the configuration, the aggregation can be quickly and efficiently managed.

In the deaggregate node of the invention, a preferred aspect of the invention is that the process request information of the processing message is information used to request the release of the QoS path within the area through reception of at least one release request message when the movement of the aggregate node is detected. As a result of the configuration, the QoS path before to the handover can be quickly released through reception of one release request message.

In the present invention, a deaggregate node is provided in a communication network in which a mobile node and a communication partner node that is a communication partner of the mobile node communicate over an area in which signaling sessions between the mobile node and the communication partner node are aggregated by an aggregate node. The aggregate node and the deaggregate node are positioned on an edge of the aggregated area. A relay node that relays a signaling message between the deaggregate node and the communication partner node is provided. When the mobile node under the aggregate node itself moves from the aggregate node, the deaggregate node includes a receiving means that receives from the aggregate node a movement message of the movement of the mobile node including a processing message including process request information of after the movement of the mobile node starts. The deaggregate node also includes a transitioning means that transitions the deaggregate node itself to a mode performing a release process for a QoS path within the area configured between the aggregate node and the deaggregate node itself, based on the received movement message. The deaggregate node also includes a release processing means that releases the QoS path within the area when at least one release request message requesting release of the QoS path within the area is received. As a result of the configuration, the aggregation can be quickly and efficiently managed.

In the deaggregate node of the invention, a preferred aspect of the invention is that the process request information of the processing message is information used to request the release of the QoS path within the area through reception of at least one release request message, when the movement of the mobile node is detected. As a result of the configuration, the QoS path before to the handover can be quickly released through reception of one release request message.

The aggregation control method, the aggregate node, and the deaggregate node of the present invention are configured as described above. Aggregation can be quickly and efficiently managed.

### BRIEF DESCRIPTION OF THE DRAWINGS

FIG. 1 is a schematic diagram of an example of a network configuration in an aggregation control method according to a first embodiment to a third embodiment of the present invention;

FIG. 2 is a sequence chart of an example of an operation sequence in the aggregation control method according to the first embodiment of the invention;

FIG. 3 is a block diagram of an example of a configuration of an aggregate node according to the first embodiment of the invention;

FIG. 4 is a block diagram of an example of a configuration of a deaggregate node according to the first embodiment of the invention, corresponding to before a movement of the aggregator;

FIG. 5 is a sequence chart of an example of an operation sequence in an aggregation control method according to a second embodiment of the invention;

FIG. 6 is a block diagram of an example of a configuration of an aggregate node according to the second embodiment of the invention;

FIG. 7 is a sequence chart of an example of an operation sequence in an aggregation control method according to the third embodiment of the invention; and

FIG. 8 is a schematic diagram of an example of a conventional network configuration including aggregated sessions.

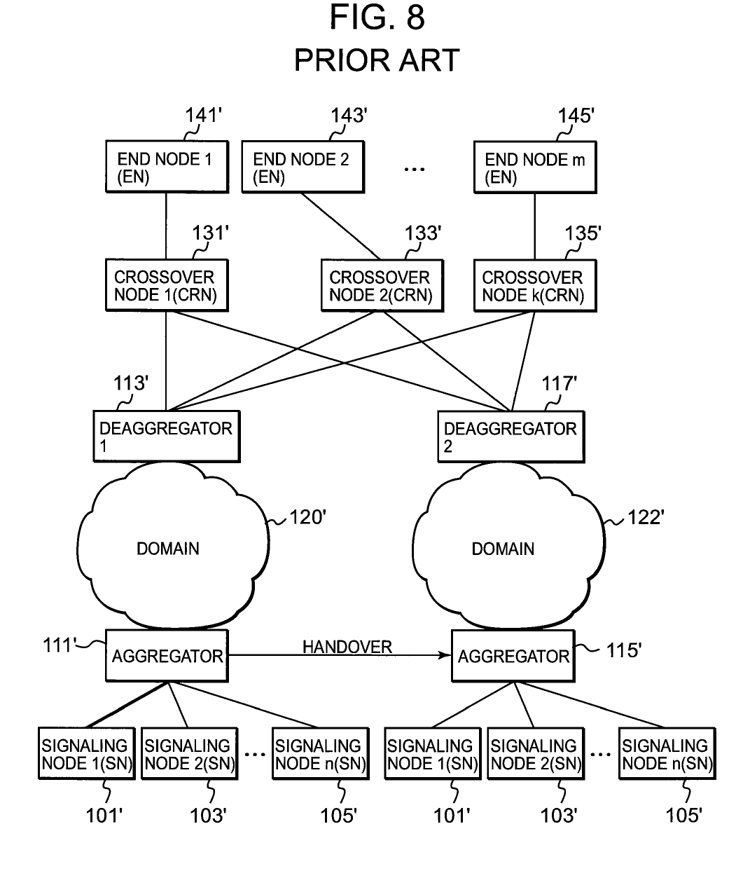

### BEST MODE FOR CARRYING OUT THE INVENTION

### First Embodiment

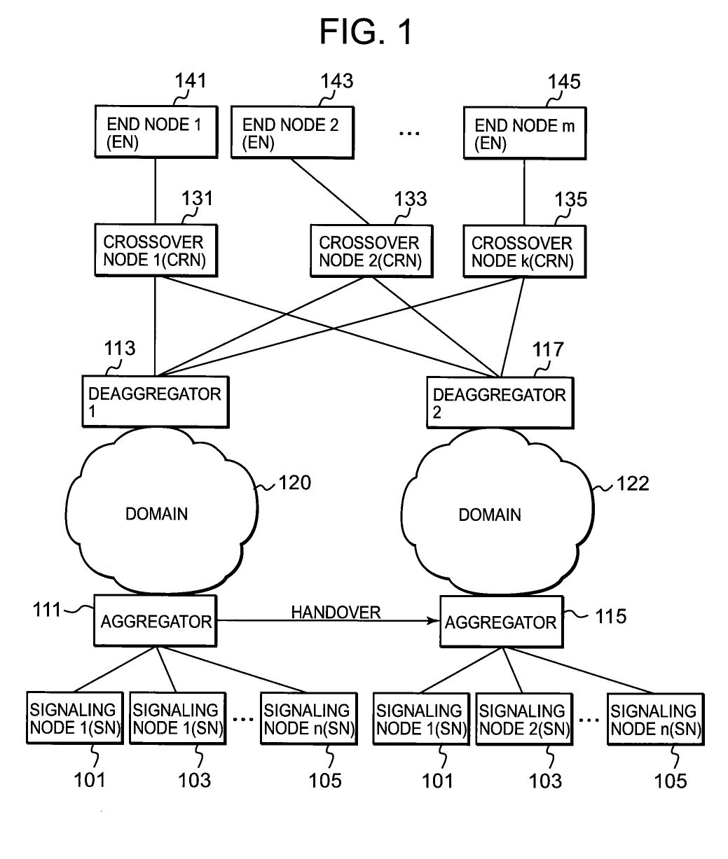

Hereafter, an aggregation control method, an aggregate node, and a deaggregate node according to a first embodiment of the present invention will be described with reference to FIG. 1 to FIG. 4. FIG. 1 shows an example of a network configuration in the aggregation control method according to the first embodiment of the invention. FIG. 1 only shows required network elements related to processing operations. However, a node that can process signaling can be further provided between a deaggregator 113 and an end node 141. k, m, and n used in FIG. 1 indicate arbitrary natural numbers used to explain the first embodiment of the invention. It is clear to a person skilled in the art that actual values do not affect the efficient operation according to the first embodiment of the invention. Aggregators 111 and 115 and deaggregators 113 and 117 are respectively positioned on the edges of domains 120 and 122. In FIG. 1 to FIG. 4, the aggregator 111 (and the aggregator 115) is shown to be a separate node from signal node 101 to signal node 105. However, the aggregator 111 (and the aggregator 115) can function as the signal node 101 to signal node 105. For example, the aggregator 111 (and the aggregator 115) and the signal node 101 to signal node 105 can be a single node.

As shown in FIG. 1, sessions used by nodes (signal node 101 to signal node 105) under the aggregator 111 and the deaggregator 113, and communication partner nodes (end node 141 to end node 145) are aggregated between the aggregator 111 and the deaggregator 113. A tunnel QoS path is established. At this time, to aggregate the sessions used between the lower nodes (signal node 101 to signal node 105) and the communication partner nodes (end node 141 to end node 145), the aggregator 111 is required to, for example, modify an end-to-end message (a message in the sessions used between the lower nodes [signal node 101 to signal node 105] and the communication partner nodes [end node 141 to end node 145]) between the aggregator 111 and the deaggregator 113, so that the end-to-end message is not processed by an internal node in the domain 120.

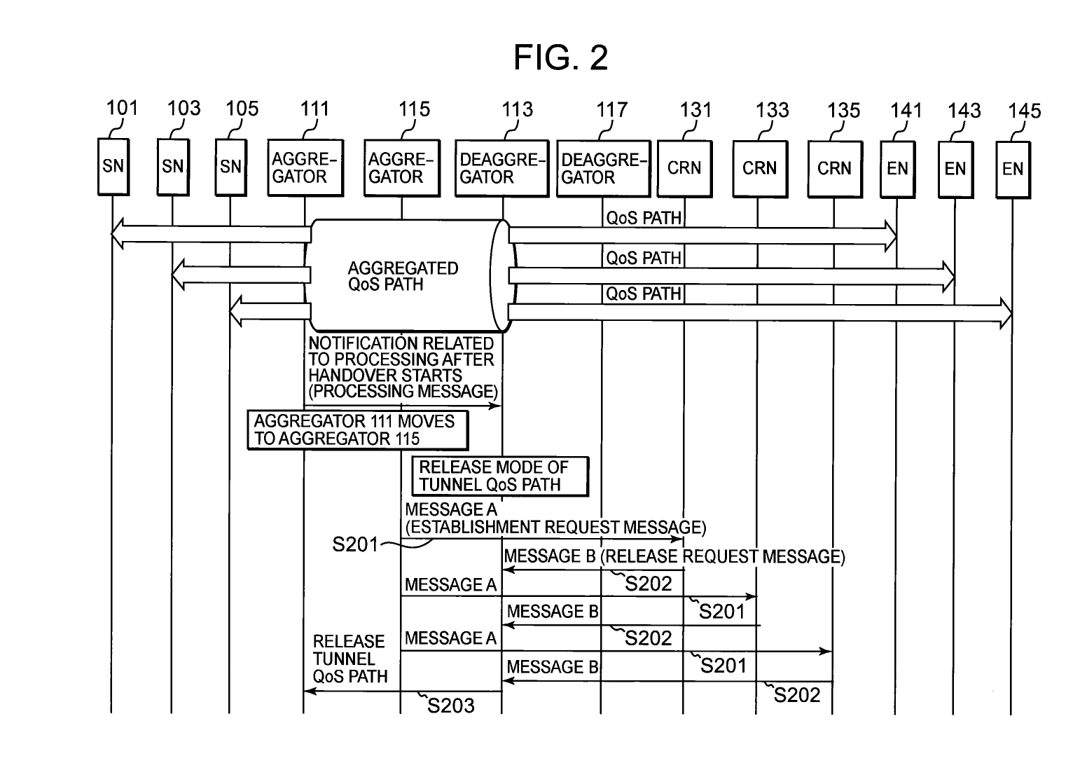

As shown in FIG. 2, the aggregator 111 notifies the deaggregator 113 or a nearest access router (not shown) of a process performed after a handover (movement) of the aggregator 111 itself starts. The aggregator 111 gives the notification in advance as a processing message. Content of the notification is, for example, as follows: “when a start of an aggregator 111 handover is detected, all tunnel QoS paths can be released through reception of a single tear message because all aggregated sessions become unnecessary.” Here, the aggregator 111 moves to a location of the aggregator 115. In accompaniment, the signal node 101 to signal node 105 also move under the aggregator 115. The deaggregator 113 changes to a deaggregator 117.

Here, an example of an operation sequence in the aggregation control method according to the first embodiment of the invention will be described, with reference to FIG. 2. As shown in FIG. 2, when the deaggregator 113 (or the nearest access router [not shown]) detects the aggregator 111 handover (movement), the deaggregator 113 enters a release mode. In the release mode, the deaggregator 113 releases all tunnel QoS paths as a result of receiving a single tear message from upstream. When the nearest access router (not shown) detects the handover, the access outer preferably notifies the deaggregator 113.

The aggregator 115 (the aggregator 111 that has moved) transmits a message A (establishment request message) to respective communication partner nodes (end node 141 to end node 145), via the deaggregator 117 (Step S201). The message A is for establishing a new QoS path. As in a technology disclosed in Non-Patent Document 3, the message A includes an internet protocol (IP) address of a communication partner node of a lower signal node and information required for CRN discovery (such as information on a session identifier [ID] of each end-to-end QoS path). The message A also includes an IP address of the deaggregator 113 (the message A can also explicitly include information stating that the sessions are aggregated).

Each QNE of a relay node receiving the message A compares, for example, a routing state value held by the QNE itself and value of the session ID included in the message A, and a QNE adjacent to the message transmitting source (when a direction of data flow is from the signal node side to the end node side) or a QNE adjacent to a message transmitting destination (when the direction of data flow is from the end node side to the signal node side), thereby identifying whether the QNE itself is the CRN. A method of identifying the CRN is not limited to this method. The above-described QNE refers to an NE (a node having NSIS function) having NSIS signaling layer protocol (NSLP) for QoS. Details thereof are disclosed in Non-Patent Document 2.

Each QNE (CRN 131 to CRN 135, herein) recognizing itself to be a CRN transmits a tear message (message B [release request message], herein) including information stating that the QNE itself is the CRN in a direction in which the aggregator 111 had been present (to the deaggregator 113), for the release of the previous QoS paths (Step S202). The deaggregator 113 receives the tear message from one of the CRN and quickly releases all tunnel QoS paths (Step S203).

As a result of a configuration such as that described above, the deaggregator 113 can quickly release the tunnel QoS paths by receiving an ordinary tear message from one of the CRN. The deaggregator 113 can release the tunnel QoS paths without sending an update message into the tunnel. The deaggregator 113 can release the tunnel QoS paths without referencing a mapping of information on the end-to-end QoS path and the inside of the tunnel. The deaggregator 113 is not required to receive all tear messages from the CRN. Therefore, the deaggregator 113 is not affected by an error in the tear message occurring between the deaggregator 113 and the CRN. These effects are similarly achieved according to a second embodiment and a third embodiment, described hereafter.

Here, the present invention does not apply to a method for detecting that the handover has started. However, as a detection method, a method of detecting that the handover has started when a deaggregator does not respond to an ordinary update message can be considered. A method in which an access router performs the detection and the like can also be considered.

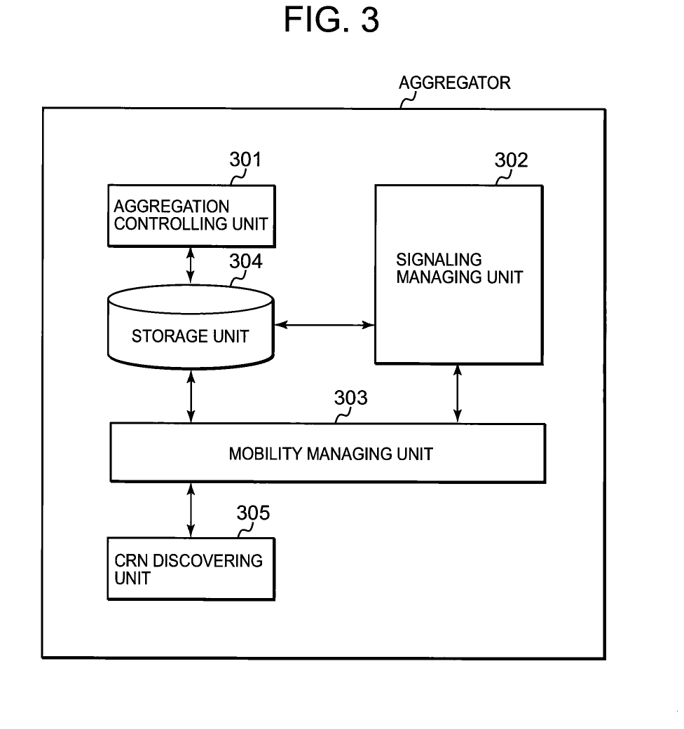

Next, an example of a configuration of an aggregate node (aggregator) according to the first embodiment of the present invention will be described with reference to FIG. 3. As shown in FIG. 3, the aggregator includes an aggregation controlling unit 301, a signaling managing unit 302 (equivalent to the above-described transmitting means), a mobility managing unit 303 (equivalent to the above-described message generating means), a storage unit 304, and a CRN discovering unit 305. The aggregation controlling unit 301 controls an actual aggregation of data communication sessions. Control performed by the aggregation controlling unit 301 includes, for example, filtering data packets, and adding a new header to a packet and encapsulating the packet when tunneling is required.

The signaling managing unit 302 controls a received signaling message and processes the signaling message. For example, the signaling managing unit 302 sends a generated processing message to the deaggregator 113 and the above-described establishment request message towards the end node 141 to end node 145. The mobility managing unit 303 maintains and manages a trail of mobility status of the aggregator. For example, the mobility managing unit 303 can generate the above-described processing message. The storage unit 304 stores, for example, related information on a current end-to-end signaling message and the aggregated sessions. The related information includes ID information of the previous tunnel QoS paths and the like. The storage unit 304 can also store information requiring storage through a series of processes.

The CRN discovering unit 305 performs a process for discovering the CRN. In a specific example, the CRN discovering unit 305 generates the message A to establish a new QoS path. The message A includes information required to discover the CRN (for example, information on the session ID of each end-to-end QoS path). The signaling managing unit 302 transmits the generated message A towards respective communication partner end node 141 to end node 145, via the deaggregator 117. The message A can also include other pieces of information (such as information on flow ID for uniformly identifying a flow prior to movement and path type ID). Details of CRN discovery are disclosed in, for example, above-described Non-Patent Document 3. Processes performed by each unit of the aggregator according to the first embodiment of the present invention are merely examples. Other processes can be performed. A process performed by a certain unit can be performed by another unit.

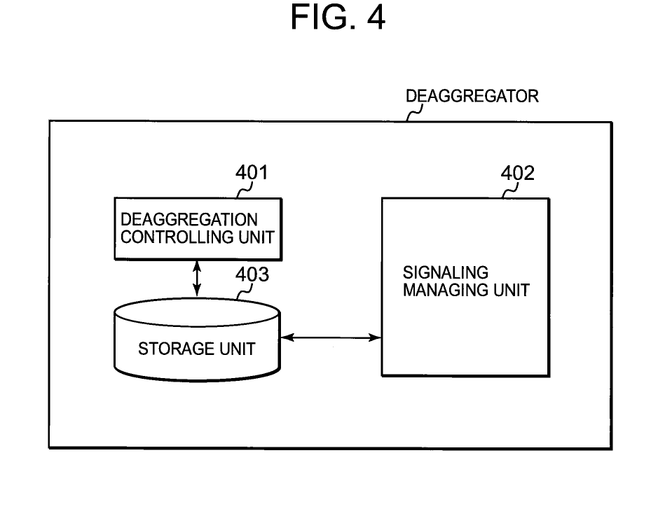

Next, an example of a configuration of a deaggregate node (the deaggregator 113, herein) according to the first embodiment of the invention, corresponding to before the movement of the aggregate node, will be described with reference to FIG. 4. As shown in FIG. 4, the deaggregator includes a deaggregation controlling unit 401, a signaling managing unit 402 (equivalent to the above-described receiving means, movement detecting means, transitioning means, and release processing means), and a storage unit 403. The deaggregation controlling unit 401 manages a deaggregation processing of data traffic. The signaling managing unit 402 processes a received signaling message.

The signaling managing unit 402 receives a processing message from the aggregator 111 giving notification related to a process performed after the above-described start of a handover. When the aggregator 111 handover is detected, the signaling message unit 402 changes the deaggregator 113 to release mode. In release mode, the deaggregator 113 releases the tunnel QoS paths established before the aggregator 111 handover. The signaling managing unit 402 releases the previous tunnel QoS paths based on the above-described message B received from the CRN 131 to CRN 135. The storage unit 403 stores, for example, related information on a current end-to-end signaling message and the aggregated sessions. The related information includes ID information of the previous tunnel QoS paths and the like. The storage unit 403 can also store information requiring storage through a series of processes. Processes performed by each unit of the deaggregator according to the first embodiment of the present invention are merely examples. Other processes can be performed. A process performed by a certain unit can be performed by another unit.

### Second Embodiment

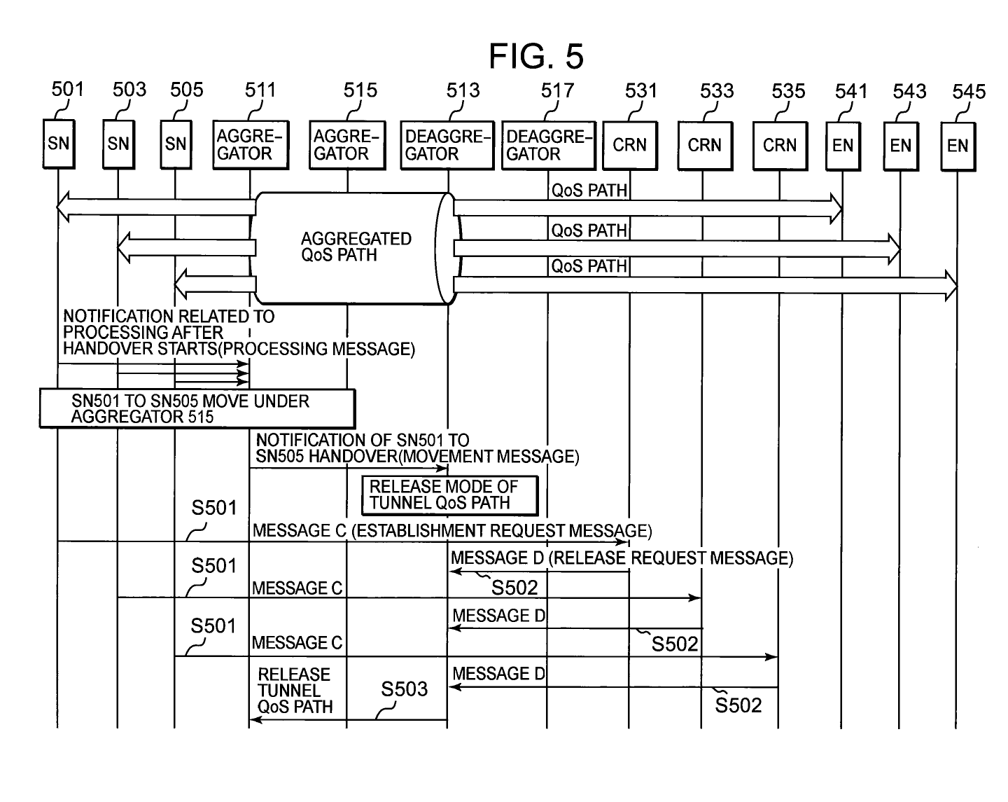

An aggregation control method, an aggregate node, and a deaggregate node according to a second embodiment of the invention will be described below, with reference to FIG. 4 to FIG. 6. A network configuration in the aggregation control method according to the second embodiment of the invention is the same as that according to the first embodiment. Explanation thereof is omitted. According to the second embodiment of the present invention, sessions used by the MN and the communication partner nodes (end node 541 to end node 545) simultaneously holding a plurality of sessions are aggregated between an aggregator 511 and a deaggregator 513. The tunnel QoS paths are established (equivalent to when the signal node 101 to signal node 105 configure a single MN in FIG. 1). In FIG. 5, the aggregator 511 (and the aggregator 515) is shown to be a separate node from the signal node 501 to signal node 505. However, the aggregator 511 (and the aggregator 515) can function as the signal node 501 to signal node 505. For example, the aggregator 511 (and the aggregator 515) and the signal node 501 to signal node 505 can be a single node.

As shown in FIG. 5, the SN (signal node 501 to signal node 505) notifies the aggregator 511 (or can also be the deaggregator 513 or a nearest access router [not shown]) of a process performed after a handover of the SN itself starts. The SN gives the notification in advance as a processing message. Content of the notification is, for example, as follows: “when the MN detects that the handover has started, all tunnel QoS paths can be released through reception of a single tear message because all aggregated sessions become unnecessary.” The SN (signal node 501 to signal node 505) moves under the aggregator 515.

When the aggregator 511 (or can also be the deaggregator 513 or the nearest access router [not shown]) detects the SN (signal node 501 to signal node 505) handover, the aggregator 511 notifies the deaggregator 513 of the detection through a movement message. As a result, the deaggregator 513 enters release mode. In release mode, the deaggregator 513 releases all tunnel QoS paths as a result of receiving a single tear message from upstream. When the deaggregator 513 directly detects that the SN (signal node 501 to signal node 505) handover has started, notification is not necessary.

The SN (signal node 501 to signal node 505) then transmits a message C (establishment request message) to respective communication partner nodes (end node 541 to end node 545), via the aggregator 515 and the deaggregator 513 (Step S501). The message C is for establishing a new QoS path. As according to the above-described first embodiment, the message C includes an IP address of a communication partner node of a lower signal node and information required for CRN discovery (such as information on a session identifier [ID] of each end-to-end QoS path). The message C also includes an IP address of the deaggregator 513 (the message C can also explicitly include information stating that the sessions are aggregated).

Each QNE of a relay node receiving the message C compares, for example, a routing state value held by the QNE itself and value of the session ID included in the message C, and a QNE adjacent to the message transmitting source (when a direction of data flow is from the signal node side to the end node side) or a QNE adjacent to a message transmitting destination (when the direction of data flow is from the end node side to the signal node side), thereby identifying whether the QNE itself is the CRN. A method of identifying the CRN is not limited to this method.

Each QNE (CRN 531 to CRN 535, herein) recognizing itself to be the CRN transmits a tear message (message D [release request message], herein) including information stating that the QNE itself is the CRN to the deaggregator 513, for the release of the previous QoS path (Step S502). The deaggregator 513 receives the tear message from one of the CRN and quickly releases all tunnel QoS paths (Step S503).

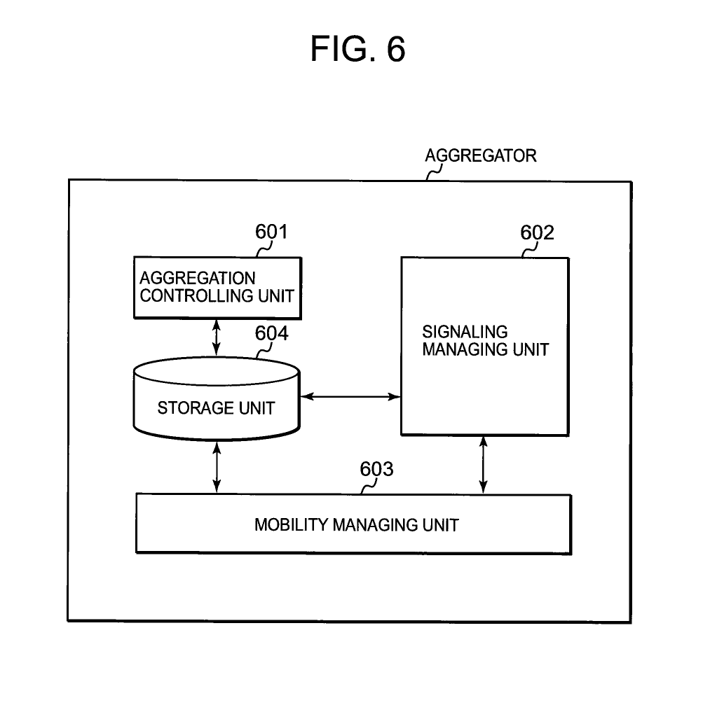

Next, an example of a configuration of an aggregate node (aggregator) according to the second embodiment of the invention will be described, with reference to FIG. 6. As shown in FIG. 6, the aggregator includes an aggregation controlling unit 601, a signaling managing unit 602 (equivalent to the above-described receiving means, movement detecting means, and transmitting means), a mobility managing unit 603 (equivalent to the above-described message generating means), and a storage unit 604. The aggregation controlling unit 601 controls the actual aggregation of the data communication sessions. Control performed by the aggregation controlling unit 601 includes, for example, filtering data packets, and adding a new header to a packet and encapsulating the packet when tunneling is required.

The signaling managing unit 602 controls a received signaling message and processes the signaling message. For example, the signaling managing unit 602 receives the above-described processing message from the SN [signal node 501 to signal node 505], detects the SN [signal node 501 to signal node 505] handover, and sends a generated movement message to the deaggregator 513. The mobility managing unit 603 maintains and manages a trail of mobility status of the aggregator. For example, when the signaling managing unit 602 detects the SN [signal node 501 to signal node 505] handover, the mobility managing unit 603 generates the movement message notifying the deaggregator 513 of the detection.

The storage unit 604 stores, for example, related information on a current end-to-end signaling message and the aggregated sessions. The related information includes ID information of the previous tunnel QoS paths and the like. The storage unit 604 can also store information requiring storage through a series of processes. Processes performed by each unit of the aggregator according to the second embodiment of the present invention are merely examples. Other processes can be performed. A process performed by a certain unit can be performed by another unit.

Next, an example of a configuration of a deaggregate node (the deaggregator 513, herein) according to the second embodiment of the invention, corresponding to before the movement of the aggregator, will be described. A block diagram of constituent elements of the deaggregate node according to the second embodiment of the invention is the same as the block diagram of the deaggregate node according to the first embodiment shown in FIG. 4. Therefore, the deaggregate node according to the second embodiment of the invention is described with reference to FIG. 4. As shown in FIG. 4, the deaggregator includes the deaggregation controlling unit 401, the signaling managing unit 402 (equivalent to the above-described receiving means, transitioning means, and release processing means), and the storage unit 403. The deaggregation controlling unit 401 manages the deaggregation processing of data traffic. The signaling managing unit 402 processes the received signaling message. For example, the signaling managing unit 402 receives the movement message from the aggregator 511 giving notification that the SN [signal node 501 to signal node 505] handover has started. Based on the movement message, the signaling managing unit 402 changes the deaggregator 513 to release mode. In the release mode, the tunnel QoS paths between the aggregator 511 and the deaggregator 513 before the SN [signal node 501 to signal node 505] handover are released.

The signaling managing unit 402 releases the previous QoS paths (the tunnel QoS paths between the aggregator 511 and the deaggregator 513) based on the above-described message D received from the CRN 531 to 535. The storage unit 403 stores, for example, related information on a current end-to-end signaling message and the aggregated sessions. The related information includes ID information of the previous tunnel QoS path and the like. The storage unit 403 can also store information requiring storage through a series of processes. Processes performed by each unit of the deaggregator according to the first embodiment of the present invention are merely examples. Other processes can be performed. A process performed by a certain unit can be performed by another unit.

### Third Embodiment

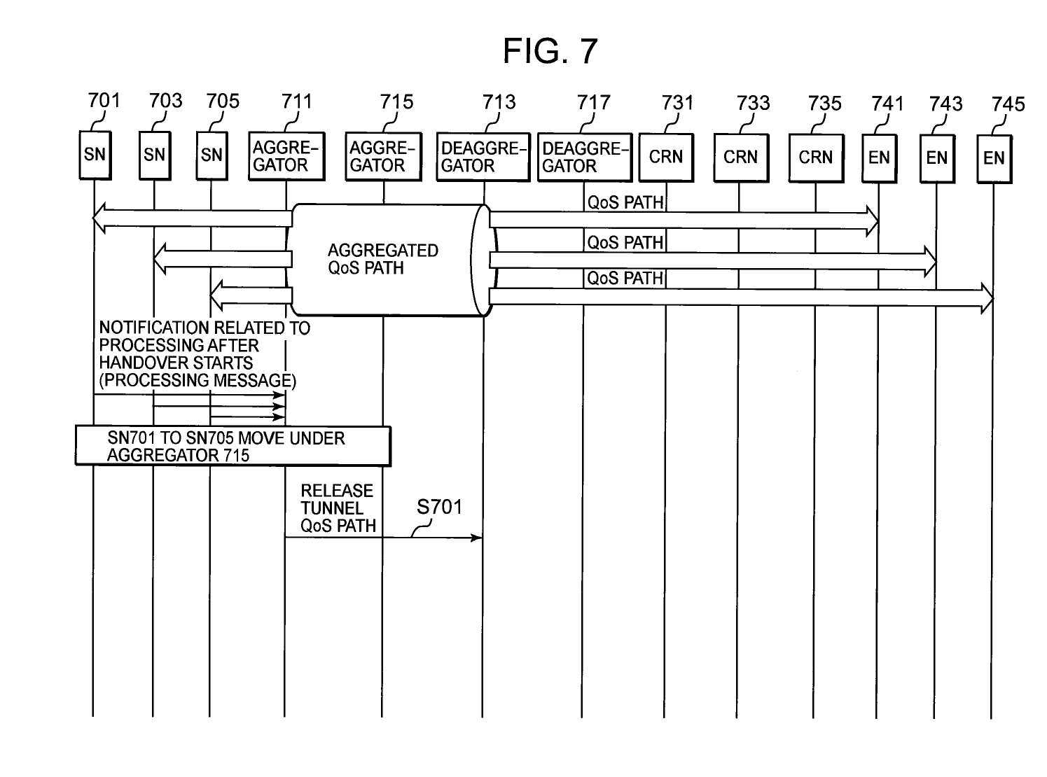

An aggregation control method, an aggregate node, and a deaggregate node according to a third embodiment of the invention will be described below, with reference to FIG. 4, FIG. 6, and FIG. 7. A network configuration in the aggregation control method according to the third embodiment of the invention is the same as that according to the first embodiment and the second embodiment. Explanation thereof is omitted. According to the third embodiment of the present invention, sessions used by the MN and the communication partner nodes (end node 741 to end node 745) simultaneously holding a plurality of sessions are aggregated between an aggregator 711 and a deaggregator 713. The tunnel QoS paths are established (equivalent to when the signal node 101 to signal node 105 configure a single MN in FIG. 1). In FIG. 7, the aggregator 711 (and the aggregator 715) is shown to be a separate node from signal node 701 to signal node 705. However, the aggregator 711 (and the aggregator 715) can function as the signal node 701 to signal node 705. For example, the aggregator 711 (and the aggregator 715) and the signal node 701 to signal node 705 can be a single node.

As shown in FIG. 7, the SN (signal node 701 to signal node 705) notifies the aggregator 711 (or can also be the deaggregator 713 or a nearest access router [not shown]) of a process performed after a handover of the SN itself starts. The SN gives the notification in advance as a processing message. Content of the notification is, for example, as follows: “when the MN detects that the handover has started, all tunnel QoS paths can be released without waiting for a tear message because all aggregated sessions become unnecessary.” The SN (signal node 701 to signal node 705) moves under the aggregator 715.

When the aggregator 711 (or can also be the deaggregator 713 or a nearest access router [not shown]) detects the SN (signal node 701 to signal node 705) handover, all tunnel QoS paths between the aggregator 711 and the deaggregator 713 are released (Step S701). When the nearest access router (not shown) detects the SN (signal node 701 to signal node 705) handover, the access router notifies the aggregator 711 or the deaggregator 713 of the detection. The notification serves as a trigger for the release of the tunnel QoS paths between the aggregator 711 and the deaggregator 713. As a result, the aggregator 711 or the deaggregator 713 can release all tunnel QoS paths without receiving the tear message.

Next, an example of a configuration of an aggregate node (aggregator) according to the third embodiment of the invention will be described. A block diagram of constituent elements of the aggregate node according to the third embodiment of the invention is the same as the block diagram of the aggregate node according to the second embodiment shown in FIG. 6. Therefore, the aggregate node according to the third embodiment of the invention will be described with reference to FIG. 6. As shown in FIG. 6, the aggregator includes the aggregation controlling unit 601, the signaling managing unit 602 (equivalent to the above-described receiving means and movement detecting means), the mobility managing unit 603 (equivalent to the above-described release processing means), and the storage unit 604. The aggregation controlling unit 601 controls the actual aggregation of the data communication sessions. Control performed by the aggregation controlling unit 601 includes, for example, filtering data packets, and adding a new header to a packet and encapsulating the packet when tunneling is required.

The signaling managing unit 602 controls a received signaling message and processes the signaling message. For example, the signaling managing unit 602 receives the above-described processing message and detects the SN (signal node 701 to signal node 705) handover. The mobility managing unit 603 maintains and manages a trail of mobility status of the aggregator. For example, when the signaling managing unit 602 detects the SN [signal node 701 to signal node 705] handover, the mobility managing unit 603 can release all tunneling QoS paths between the aggregator 711 and the deaggregator 713.

The storage unit 604 stores, for example, related information on a current end-to-end signaling message and the aggregated sessions. The related information includes ID information of the previous tunnel QoS path and the like. The storage unit 604 can also store information requiring storage through a series of processes. Processes performed by each unit of the aggregator according to the third embodiment of the present invention are merely examples. Other processes can be performed. A process performed by a certain unit can be performed by another unit.

Next, an example of a configuration of a deaggregate node (the deaggregator 813, herein) according to the third embodiment of the invention, corresponding to before the movement of the aggregator, will be described. A block diagram of constituent elements of the deaggregate node according to the third embodiment of the invention is the same as the block diagram of the deaggregate node according to the first embodiment shown in FIG. 4. Therefore, the deaggregate node according to the third embodiment of the invention is described with reference to FIG. 4. As shown in FIG. 4, the deaggregator includes the deaggregation controlling unit 401, the signaling managing unit 402, and the storage unit 403. The deaggregation controlling unit 401 manages the deaggregation processing of data traffic. The signaling managing unit 402 processes the received signaling message.

When the deaggregator 713 itself detects the SN (signal node 701 to signal node 705) handover, the signaling managing unit 402 releases all tunnel QoS paths between the aggregator 711 and the deaggregator 713 based on the detection. When the nearest access router (not shown) detects the SN (signal node 701 to signal node 705) handover and the deaggregator 713 itself receives information on the detection from the access router (not shown), the signaling managing unit 402 releases all tunnel QoS paths between the aggregator 711 and the deaggregator 713.

The storage unit 403 stores, for example, related information on a current end-to-end signaling message and the aggregated sessions. The related information includes ID information of the previous tunnel QoS path and the like. The storage unit 403 can also store information requiring storage through a series of processes. Processes performed by each unit of the deaggregator according to the third embodiment of the present invention are merely examples. Other processes can be performed. A process performed by a certain unit can be performed by another unit.

A concept of the present invention can also be applied to an ordinary handover (for example, Patent Document 3). For example, when a RESERVE (Refresh) message is transmitted from a corresponded node (CN) as is ordinarily transmitted over a previous QoS path after the MN handover has started, the MN that is an intended responder is not present. Therefore, a RESPONSE message is not returned to the CN (error occurs). To prevent a situation such as this, a notification can be given in advance to the QNE adjacent to the MN for “the QNE to serve as the responder instead when the handover is detected”. As a result, the RESPONSE message can be returned to the CN and the occurrence of an error can be prevented.

Each embodiment of the invention has been described above. Each functional block used in the explanations of each embodiment, described above, can be actualized as a large scale integration (LSI) that is typically an integrated circuit. Each functional block can be individually formed into a single chip. Alternatively, some or all of the functional blocks can be included and formed into a single chip. Although referred to here as the LSI, depending on differences in integration, the integrated circuit can be referred to as the integrated circuit (IC), a system LSI, a super LSI, or an ultra LSI. The method of forming the integrated circuit is not limited to LSI and can be actualized by a dedicated circuit or a general-purpose processor. A field programmable gate array (FPGA) that can be programmed after LSI manufacturing or a reconfigurable processor of which connections and settings of the circuit cells within the LSI can be reconfigured can be used. Furthermore, if a technology for forming the integrated circuit that can replace LSI is introduced as a result of the advancement of semiconductor technology or a different derivative technology, the integration of the functional blocks can naturally be performed using the technology. For example, the application of biotechnology is a possibility.

### INDUSTRIAL APPLICABILITY

The aggregation control method, the aggregate node, and the deaggregate node of the present invention can quickly and efficiently manage aggregation. Therefore, the aggregation control method, the aggregate node, and the deaggregate node of the present invention are effective as an aggregation control method, an aggregate node, and a deaggregate node used to control aggregation in a communication network including aggregated sessions.

1. An aggregation control method in a communication network in which a mobile node and a communication partner node that is a communication partner of the mobile node communicate over an area in which signaling sessions between the mobile node and the communication partner node are aggregated by an aggregate node, the aggregate node and a deaggregate node are positioned on an edge of the aggregated area, and a relay node that relays a signaling message between the deaggregate node and the communication partner node is provided, the aggregation control method comprising the steps of:
when the aggregate node moves from the edge of the aggregated area to an edge of another area,
transitioning, by the deaggregate node, the deaggregate node itself to a mode performing a release process for a QoS path within the area configured between the aggregate node and the deaggregate node itself, based on a processing message including process request information of after the movement starts received in advance from the aggregate node before movement;
transmitting, by the aggregate node, an establishment request message for establishing a new QoS path after movement to the communication partner node;
transmitting, by the relay node, a release request message requesting release of the QoS path within the area to the deaggregate node when the relay node judges that the relay node itself is a crossover node at which new and old communication paths converge and separate on the communication network because of the movement, based on the transmitted establishment request message; and
releasing, by the deaggregate node, the QoS path within the area when at least one release request message is received.

2. The aggregation control method according to claim 1, wherein the process request information of the processing message is information used to request the release of the QoS path within the area through reception of at least one release request message when the movement of the aggregate node is detected.

3. An aggregation control method in a communication network in which a mobile node and a communication partner node that is a communication partner of the mobile node communicate over an area in which signaling sessions between the mobile node and the communication partner node are aggregated by an aggregate node, the aggregate node and a deaggregate node are positioned on an edge of the aggregated area, and a relay node that relays a signaling message between the deaggregate node and the communication partner node is provided, the aggregation control method comprising the steps of:
when the mobile node under the aggregate node moves from the aggregate node,
transmitting, by the aggregate node, a movement message of the movement of the mobile node including a processing message including process request information of after the movement starts, received in advance from the mobile node before the movement of the mobile node, to the deaggregate node;
transitioning, by the deaggregate node, the deaggregate node itself to a mode performing a release process for a QoS path within the area configured between the aggregate node and the deaggregate node itself, based on the received movement message;
transmitting, by the mobile node, an establishment request message for establishing a new QoS path after movement to the communication partner node;
transmitting, by the relay node, a release request message requesting release of the QoS path within the area to the deaggregate node when the relay node judges that the relay node itself is a crossover node at which new and old communication paths converge and separate on the communication network because of the movement, based on the transmitted establishment request message; and
releasing, by the deaggregate node, the QoS path within the area when at least one release request message is received.

4. The aggregation control method according to claim 3, wherein the process request information of the processing message is information used to request the release of the QoS path within the area through reception of at least one release request message when the movement of the mobile node is detected.

5. An aggregation control method in a communication network in which a mobile node and a communication partner node that is a communication partner of the mobile node communicate over an area in which signaling sessions between the mobile node and the communication partner node are aggregated by an aggregate node, the aggregate node and a deaggregate node are positioned on an edge of the aggregated area, and a relay node that relays a signaling message between the deaggregate node and the communication partner node is provided, the aggregation control method comprising the steps of:
when the mobile node under the aggregate node moves from the aggregate node,
releasing, by the aggregate node, the QoS path configured within the area configured between the aggregate node itself and the deaggregate node, based on a processing message including process request information of after the movement starts received in advance from the mobile node before the movement of the mobile node.

6. The aggregation control method according to claim 5, wherein the process request information of the processing message is information used to request the release of the QoS path within the area without reception of a release request message for the QoS path within the area when the movement of the mobile node is detected.

7. An aggregate node in a communication network in which a mobile node and a communication partner node that is a communication partner of the mobile node communicate over an area in which signaling sessions between the mobile node and the communication partner node are aggregated by the aggregate node, the aggregate node and a deaggregate node are positioned on an edge of the aggregated area, and a relay node that relays a signaling message between the deaggregate node and the communication partner node is provided, the aggregate node comprising:
when the aggregate node itself moves from the edge of the aggregated area to an edge of another area,
a message generating means that generates a processing message including process request information of after the aggregate node itself starts moving, before moving; and
a transmitting means that transmits the generated processing message to the deaggregate node and an establishment request message for establishing a new QoS path after movement to the communication partner node.

8. The aggregate node according to claim 7, wherein the process request information of the processing message is information used to request the release of the QoS path within the area through reception of at least one release request message requesting release of the QoS path within the area configured between the aggregate node and the deaggregate node, when the movement of the aggregate node is detected.

9. An aggregate node in a communication network in which a mobile node and a communication partner node that is a communication partner of the mobile node communicate over an area in which signaling sessions between the mobile node and the communication partner node are aggregated by the aggregate node, the aggregate node and a deaggregate node are positioned on an edge of the aggregated area, and a relay node that relays a signaling message between the deaggregate node and the communication partner node is provided, the aggregate node comprising:
when the mobile node under the aggregate node itself moves from the aggregate node,
a receiving means that receives a processing message including process request information of after the movement of the mobile node starts, from the mobile node before movement;
a movement detecting means that detects the movement of the mobile node;
a message generating means that generates a movement message of the movement of the mobile node including the processing message, when the movement detecting means detects the movement of the mobile node; and
a transmitting means that transmits the generated movement message to the deaggregate node.

10. The aggregate node according to claim 9, wherein the process request information of the processing message is information used to request the release of the QoS path within the area through reception of at least one release request message requesting release of the QoS path within the area configured between the aggregate node and the deaggregate node, when the movement of the mobile node is detected.

11. An aggregate node in a communication network in which a mobile node and a communication partner node that is a communication partner of the mobile node communicate over an area in which signaling sessions between the mobile node and the communication partner node are aggregated by the aggregate node, the aggregate node and a deaggregate node are positioned on an edge of the aggregated area, and a relay node that relays a signaling message between the deaggregate node and the communication partner node is provided, the aggregate node comprising:
when the mobile node under the aggregate node itself moves from the aggregate node,
a receiving means that receives a processing message including process request information of after the movement of the mobile node starts, from the mobile node before movement;
a movement detecting means that detects the movement of the mobile node; and
a release processing means that releases the QoS path within the area configured between the aggregate node and the deaggregate node based on the received processing message when the movement detecting means detects the movement of the mobile node.

12. The aggregate node according to claim 11, wherein the process request information of the processing message is information used to request the release of the QoS path within the area without reception of a release request message for the QoS path within the area when the movement of the mobile node is detected.

13. A deaggregate node in a communication network in which a mobile node and a communication partner node that is a communication partner of the mobile node communicate over an area in which signaling sessions between the mobile node and the communication partner node are aggregated by an aggregate node, the aggregate node and the deaggregate node are positioned on an edge of the aggregated area, and a relay node that relays a signaling message between the deaggregate node and the communication partner node is provided, the deaggregate node comprising:
when the aggregate node moves from the edge of the aggregated area to an edge of another area,
a receiving means that receives a processing message including process request information of after the movement starts from the aggregate node before movement;
a movement detecting means that detects the movement of the aggregate node;
a transitioning means that transitions the deaggregate node itself to a mode performing a release process for a QoS path within the area configured between the aggregate node and the deaggregate node itself, based on the received processing message when the movement detecting means detects the movement of the aggregate node; and
a release processing means that releases the QoS path within the area when at least one release request message requesting release of the QoS path within the area is received.

14. The deaggregate node according to claim 13, wherein the process request information of the processing message is information used to request the release of the QoS path within the area through reception of at least one release request message when the movement of the aggregate node is detected.

15. A deaggregate node in a communication network in which a mobile node and a communication partner node that is a communication partner of the mobile node communicate over an area in which signaling sessions between the mobile node and the communication partner node are aggregated by an aggregate node, the aggregate node and the deaggregate node are positioned on an edge of the aggregated area, and a relay node that relays a signaling message between the deaggregate node and the communication partner node is provided, the deaggregate node comprising:
when the mobile node under the aggregate node itself moves from the aggregate node,
a receiving means that receives from the aggregate node a movement message of the movement of the mobile node including a processing message including process request information of after the movement of the mobile node starts;
a transitioning means that transitions the deaggregate node itself to a mode performing a release process for a QoS path within the area configured between the aggregate node and the deaggregate node itself, based on the received movement message; and
a release processing means that releases the QoS path within the area when at least one release request message requesting release of the QoS path within the area is received.

16. The deaggregate node according to claim 15, wherein the process request information of the processing message is information used to request the release of the QoS path within the area through reception of at least one release request message when the movement of the mobile node is detected.
